(19) United States
(12) Patent Application Publication
(10) Pub. No.: US 2004/0098255 A1
(43) Pub. Date: May 20, 2004

(54) Generalized analysis-by-synthesis speech coding method, and coder implementing such method

(75) Inventors: Balazs Kovesi, Lannion (FR); Dominique Massaloux, Perros Guirec (FR); Claude Lamblin, Perros Guirec (FR); Yang Gao, Mission Viejo, CA (US)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignees: France Telecom, Paris (FR); Conexant Systems, Inc., Newport Beach, CA

(21) Appl. No.: 10/294,923

(22) Filed: Nov. 14, 2002

(51) Int. Cl. G10L 19/10; G10L 19/04; G10L 19/08

(52) U.S. Cl. 704/219

(57) ABSTRACT

An improved EX-CELP or RCELP encoding scheme is proposed, in which, at the encoder side, a speech signal is perceptually weighted signal prior to entering a time scale modification module, then the modified signal is transformed into another domain, such as the speech or LP short-term residual domain, using the corresponding inverse filtering operation directly or possibly combined with another processing, for instance a short-term LP filtering. A shift function is calculated in the time scale modification process to associate the position of each sample in the modified signal with its original position before the modification. The positions of the samples in the modified signal that correspond to sub-frame boundaries of the original signal are evaluated to switch filters for the inverse filtering at the appropriate instants. Therefore, the synchronization between the inverse filters and the modified signal is maintained.

### TECHNICAL FIELD

The present invention relates to coding by techniques using generalized analysis-by-synthesis speech coding, and more particularly to the technology known as Relaxed Code-Excited Linear Prediction (RCELP) and the like.

### BACKGROUND OF THE INVENTION

A large class of speech coding paradigms is built around the concept of predictive coding. Predictive speech coders are used extensively by communication and storage systems at medium to low bit rates.

The most common and practical approach for predictive speech coding is the linear prediction (LP) scheme, in which the current signal values are estimated by a linear combination of the previously transmitted and decoded signal samples. Short-term (ST) linear prediction, which is closely related to the spectral shape of the input signal, was initially used for coding speech. A long-term (LT) linear prediction was further introduced, to capture the harmonic structure of the speech signal, in particular for voiced speech segments.

The Analysis-by-Synthesis (AbS) approach has provided efficient means for an optimal analysis and coding of the short-term LP residual, using the long-term linear prediction and a codebook excitation search. The AbS scheme is the basis for a large family of speech coders, including Code-Excited Linear Prediction (CELP) coders and Self-Excited Vocoders (A. Gersho, “Advances in Speech and Audio Compression”, Proc. of the IEEE, Vol. 82, No. 6, pp. 900-918, June 1994).

The long-term LP analysis, also referred to as “pitch prediction”, at the encoder and the long-term LP synthesis at the decoder have evolved, as the speech coding technology has progressed. Initially modeled as a single-tap filter, the long-term LP was extended to include multi-tap filters (R. P. Ramachandran and P. Kabal, “Stability and Performance Analysis of Pitch Filters in Speech Coders”, IEEE Trans. on ASSP, Vol. 35, No. 7, pp. 937-948, July 1987). Then, fractional delays have been introduced, using over-sampling and sub-sampling with interpolation filters (P. Kroon and B. S. Atal, “Pitch Predictors with High Temporal Resolution”, Proc. ICASSP Vol. 2, April 1990, pp. 661-664).

Those extensions of the initial single-tap filter were designed to improve the capturing the LT redundancies produced by the glottal source in voiced speech. The better the LT matching and the better the LP excitation encoding, the better the overall performances are. Matching accuracy can also he improved by frequent refreshes of the LT parameters. However, a multi-tap LT predictor or a higher update rate for the LT filters requires the transmission of a large number of bits for their representation, and it significantly increases the bit rate. This cost can become prohibitive in the case of low bit rate coders, where other solutions are hence necessary.

To overcome some of the limitations of the above-described LT prediction approach, the concept of Generalized Analysis-by-Synthesis Coding was introduced (W. E. Kleijn et al., “Generalized Analysis-by-Synthesis Coding and its Application to Pitch Prediction”, Proc. ICASSP, Vol. 1, 1992, pp. 337-340). In this scheme, the original signal is modified prior to encoding, with the constraint that the modified signal is perceptually close or identical to the original signal. The modification is such that the coder parameters, more precisely the pitch prediction parameters, are constrained to match a specific pitch period contour. The pitch contour is obtained by the interpolation of the pitch prediction parameters on a frame-by-frame basis using a low-resolution representation for the pitch lag, which limits the bit rate needed for the representation of the LT prediction parameters.

The modification performed to match the pitch contour is called time scale modification or “time warping” (W. E. Kleijn et al., “Interpolation of the Pitch Predictor Parameters in Analysis-by-Synthesis Speech Coders”, IEEE Trans. on SAP. Vol. 2. No. 1, part 1, January 1994, pp. 42-54). The goal of the time scale modification procedure is to align the main features of the original signal with those of the LT prediction contribution to the excitation signal.

RCELP coders are derived from the conventional CELP coders by using the above-described Generalized Analysis-by-Synthesis concept applied to the pitch parameters, as described in W. B. Kleijn et al., “The RCELP Speech-Coding Algorithm”, European Trans. in Telecommunications, Vol. 4, No. 5, September-October 1994, pp. 573-582.

The main features of the RCELP coders are as follows. Like CELP coders, short-term LP coefficients are first estimated (generally once every frame, sometimes with intermediate refreshes). The frame length can vary, typically, between 10 to 30 ms. In RCELP coders, the pitch period is also estimated on a frame-by-frame basis, with a robust pitch detection algorithm. Then a pitch-period contour is obtained by interpolating the frame-by-frame pitch periods. The original signal is modified to match this pitch contour. In earlier implementations (U.S. Pat. No. 5,704,003), this time scale modification process was performed on the short-term LP residual signal. However, a preferred solution is to use a perceptually-weighted input signal, obtained by filtering the input signal through a perceptual weighting filter, as is done in J. Thyssen at al., “A candidate for the ITU-T 4 kbit/s Speech Coding Standard”, Proc. ICASSP, Vol. 2, Salt Lake City, Utah, USA, May 2001, pp. 681-684, or in Yang Gao et al., “EX-CELP: A Speech Coding Paradigm”, Proc. ICASSP, Vol. 2, Salt Lake City, Utah, USA, May 2001, pp. 689-693.

The modified speech signal may then be obtained by inverse filtering using the inverse pre-processing filter, while the subsequent coding operations can be identical to those performed in a conventional CELP coder.

It is noted that the modified input signal may actually be calculated, depending on the kind of filtering performed prior to time scale modification, and depending on the structure adopted in the CELP encoder that follows the time scale modification module.

When the perceptual weighting filter, used for the fixed codebook search of the CELP coder, is of the form A(z)/A(z/γ), where A(z) is the LP filter and γ a weighting factor, only one recursive filtering is involved in the target computation. Only the residual signal is thus needed for the codebook search. In the case of RCELP coding, computation of the modified original signal may not be required if the time scale modification has been performed on this residual signal. Perceptual weighting filters of the form A(z/γ₁)/A(z/γ₂), with weighting factors γ₁ and γ₂, are known to provide better performance, and more particularly adaptive perceptual filters, i.e. with γ₁ and γ₂ variable, as disclosed in U.S. Pat. No. 5,845,244. When such weighting filters are used in the CELP procedure, the target evaluation introduces two recursive filters.

In many CELP structures (e.g. R. Salami et al., “Design and description of CS-ACELP: a toll quality 8 kb/s speech coder”, IEEE Trans. on Speech and Audio Processing, Vol. 6, No. 2, March 1998), the intermediate filtering process feeds the current residual signal to the LP synthesis filter with the past weighted error signal as memory. The input signal is involved both in the residual computation and in the error signal update at the end of the frame processing.

In the case of RCELP, a straightforward implementation of this scheme introduces the need to compute the modified original input. However, equivalent schemes can be derived, where the modified input signal is not required. These are based on the use either of the modified residual signal if time scale modification was applied to the residual signal, or of the modified weighted input if the time scale modification was applied to the weighted speech.

In practice, most RCELP coders do not actually compute the modified original signal using the kind of structure presented above.

A block diagram of a known RCELP coder is shown in FIG. 1. An linear predictive coding (LPC) analysis module 1 first processes the input audio signal S, to provide LPC parameters used by a module 2 to compute the coefficients of the pre-processing filter 3 whose transfer function is noted F(z). This filter 3 receives the input signal S and supplies a pre-processed signal FS to a pitch analysis module 4. The pitch parameters thus estimated are processed by a module 5 to derive a pitch trajectory.

The filtered input FS is further fed to a time scale modification module 6 which provides the modified filtered signal MFS based on the pitch trajectory obtained by module 5. Inverse filtering using a filter 7 of transfer function F(z)⁻¹ is applied to the modified filtered signal MFS to provide a modified input signal MS fed to a conventional CELP encoder 8.

The digital output flow Φ of the RCELP coder, assembled by a multiplexer 9, typically includes quantization data for the LPC parameters and the pitch lag computed by modules 1 and 4, CELP codebook indices obtained by the encoder 8, and quantization data for gains associated with the LT prediction and the CELP excitation, also obtained by the encoder 8.

Instead of a direct inverse filtering function 7, conversion of the modified filtered signal into another domain can be performed. This observation holds for the prior art discussed here and also for the present invention disclosed later on. As an example, such domain may be the residual domain, the inverse preprocessing filter F(z)⁻¹ being used in conjunction with other processing, such as the short-term LP filtering of the CELP encoder. To have the problem more directly apprehended, the following discussion considers the case where the modified input signal is actually computed, i.e. when the inverse pre-processing filter 7 is explicitly used.

In most AbS speech coding methods, the speech processing is performed on speech frames having a typical length of 5 to 30 ms, corresponding to the short-term LP analysis period. Within a frame, the signal is assumed to be stationary, and the parameters associated with the frame are kept constant. This is typically true for the F(z) filter as well, and its coefficients are thus updated on a frame-by-frame basis. It will be appreciated that the LP analysis can be performed more than once in a frame, and that the filter F(z) can also vary on a subframe-by-subframe basis. This is for instance the case where intra-frame interpolation of the LP filters is used.

In the following, the word “block” will be used as corresponding to the updating periodicity of the pre-processing filter parameters. Those skilled in the art will appreciate that such “block” may typically consist of an LP analysis frame, a subframe of such LP analysis frame, etc., depending on the codec architecture.

The gain associated with a linear filter is defined as the ratio of the energy of its output signal to the energy of its input signal. Clearly, a high gain of a linear filter corresponds to a low gain of the inverse linear filter and vice versa.

It may happen that the pre-processing filters 3 calculated for two consecutive blocks have significantly different gains, while the energies of the original speech S are similar in both blocks. Since the filter gains are different, the energies of the filtered signals FS for the two blocks will be significantly different as well. Without time scale modification, all the samples of the filtered block of higher energy will be inverse-filtered by the inverse linear filter 7 of lower gain, while all the samples of the filtered block of lower energy will be inverse-filtered by the inverse linear filter 7 of higher gain. In this case, the energy profile of the modified signal MS correctly reflects that of the input speech S.

However, the time scale modification procedure causes that, near the block boundary, a portion of a first block, which may include multiple samples, can be shifted to a second, adjacent block. The samples in that portion of the first block will be filtered by an inverse filter calculated for the second block, which might have a significantly different gain. If samples of a modified filtered signal MFS of high energy are thus submitted to an inverse filter 7 having a high gain instead of a low gain, a sudden energy growth in the modified signal occurs. A listener perceives such energy growth as an objectionable ‘click’ noise.

FIG. 2 illustrates this problem, with N representing a block number, g_{d}(N) the gain of the pre-processing filter 3 for block N and gᵢ(N)=1/g_{d}(N) the gain of the inverse filter 7 for block N.

An object of the present invention is to provide a solution to avoid the above-discussed mismatch between inverse pre-processing filters (explicitly or implicitly present) and the time scale modified signal.

### SUMMARY OF THE INVENTION

The present invention is used at the encoder side of an speech codec using a EX-CELP or RCELP type of approach, where the input signal has been modified by a time scale modification process. The time scale modification is applied to a perceptually weighted version of the input signal. Afterwards, the modified filtered signal is converted into another domain, e.g. back to the speech domain or to the residual domain using a corresponding inverse filter, directly or indirectly, for instance combined with another filter.

The present invention eliminates artifacts resulting from misalignment of the time scale modified speech and of the inverse filter parameter updates, by adjusting the timing of the updates of the inverse filter involved in the above-mentioned conversion to another domain.

In the time scale modification procedure, a time shift function is advantageously calculated to locate the block boundaries within the modified filtered signal, at which the inverse filter parameter updates will take place. The time scale modification procedure generally shifts these block boundaries with respect to their positions in the incoming filtered signal. The time shift function evaluates the positions of the samples in the modified filtered signal that correspond to the block boundaries of the original signal, in order to perform the updates of the inverse pre-processing filter parameters at the most suitable positions. By updating the filter parameters at these positions, the synchronicity between the inverse filter and the time scale modified filtered signal is maintained, and the artifacts are eliminated when the modified filtered signal is converted to the other domain.

The invention thus proposes a speech coding method, comprising the steps of:

analyzing an input audio signal to determine a respective set of filter parameters for each one of a succession of blocks of the audio signal;

filtering the input signal in a perceptual weighting filter defined for each block by the determined set of filter parameters to produce a perceptually weighted signal;

modifying a time scale of the perceptually weighted signal based on pitch information to produce a modified filtered signal;

locating block boundaries within the modified filtered signal; and

processing the modified filtered signal to obtain coding parameters.

The latter processing involves an inverse filtering operation corresponding to the perceptual weighting filter. The inverse filtering operation is defined by the successive sets of filter parameters updated at the located block boundaries.

In an embodiment of the method, the step of analyzing the input signal comprises a linear prediction analysis carried out on successive signal frames, each frame being made of a number p of consecutive subframes (p≧1). Each of the “blocks” may then consist of one of these subframes. The step of locating block boundaries then comprises, for each frame, determining an array of p+1 values for locating the boundaries of its p subframes within the modified filtered signal.

The linear prediction analysis is preferably applied to each of the p subframe by means of a analysis window function centered on this subframe, whereas the step of analyzing the input signal further comprises, for the current frame, a look-ahead linear prediction analysis by means of an asymmetric look-ahead analysis window function having a support which does not extend in advance with respect to the support of the analysis window function centered on the last subframe of the current frame and a maximum aligned on a time position located in advance with respect to the center of this last subframe. In response to the (p+1)^{th} value of the array determined for the current frame falling short of the end of the frame, the inverse filtering operation is advantageously updated at the block boundary located by said (p+1)^{th} value to be defined by a set of filter coefficients determined from the look-ahead analysis.

Another aspect of the present invention relates to a speech coder, having means adapted to implement the method outlined hereabove.

### BRIEF DESCRIPTION THE DRAWINGS

FIG. 1, previously discussed, is a block diagram of a RCELP coder in accordance with the prior art;

FIG. 2, previously discussed, is a timing diagram illustrating the “click noise” problem encountered in certain RCELP coders of the type described with reference to FIG. 1;

FIG. 3 is a diagram similar to FIG. 2, illustrating the operation of a RCELP coder according to the present invention;

FIG. 4 is a block diagram of an example of RCELP coder according to the present invention;

FIG. 5 is a timing diagram illustrating analysis windows used in an particular embodiment of the invention.

### DESCRIPTION OF PREFERRED EMBODIMENTS

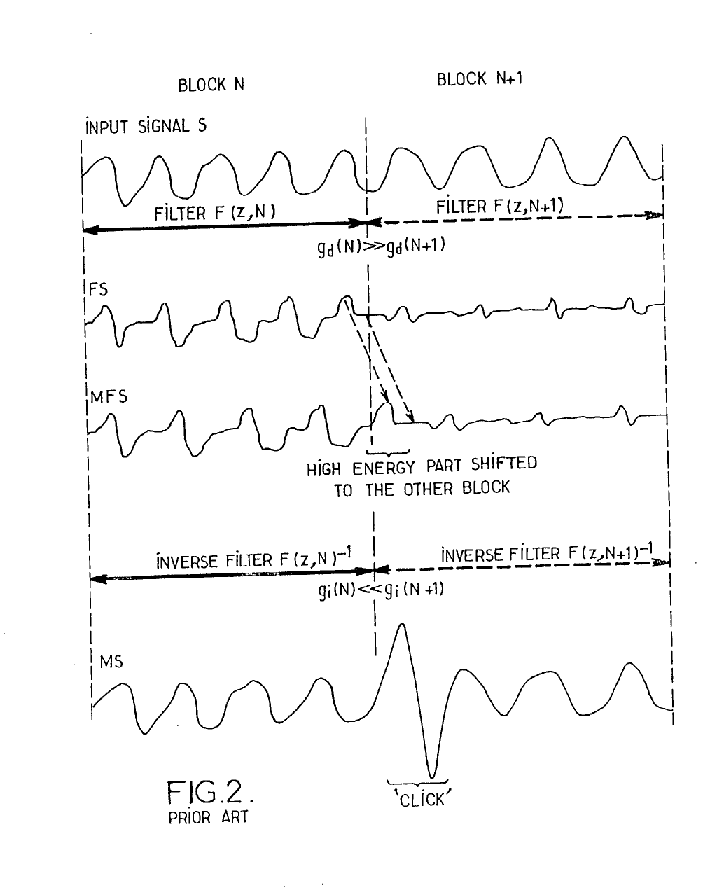

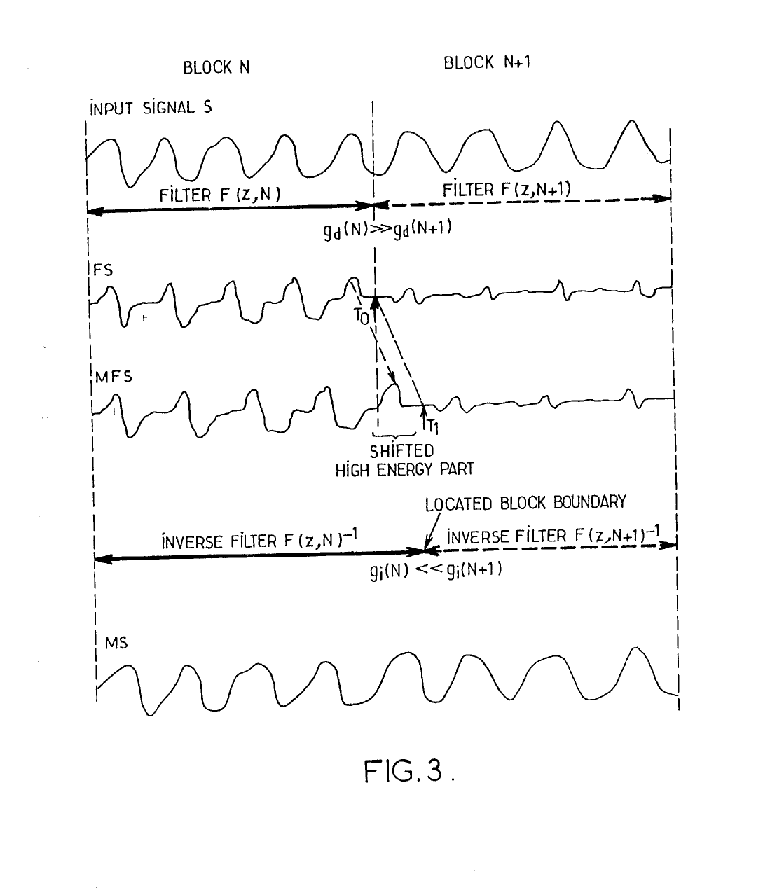

FIG. 3 illustrates how the mismatch problem apparent from FIG. 2 can be alleviated.

Instead of inverse filtering blocks of constant length related to the frame or subframe length of the input signal, a variable-length inverse filtering is applied. The boundary at which the inverse filter F(z, N+1) replaces the inverse filter F(z, N) depends on the time scale modification procedure. If T₀ designates the position of the fist sample of frame N+1 in the filtered signal FS, before the time scale modification, the corresponding sample position in the modified filtered signal is denoted as T₁ in FIG. 3. This position T₁ is provided as an output of the time scale modification procedure. In the proposed method, during the inverse filtering procedure, the inverse filter F(z, N)⁻¹ is replaced by the next inverse filter F(z, N+1)⁻¹ at sample T₁ instead of sample T₀. Therefore, each sample is inverse filtered by the filter corresponding to the perceptual weighting pre-processing filter that was used to yield the sample, which reduces the risk of gain mismatch.

If a shift to the left is observed (T₁<T₀), the samples of the modified signal after T₁ have to be filtered by the inverse filter corresponding to the next frame of the input signal. Generally, a good approximation of this filter is already known due to a look-ahead analysis performed in the LPC analysis stage. Using the filter resulting from the look-ahead analysis in this case avoids introducing any additional delay when using the present invention.

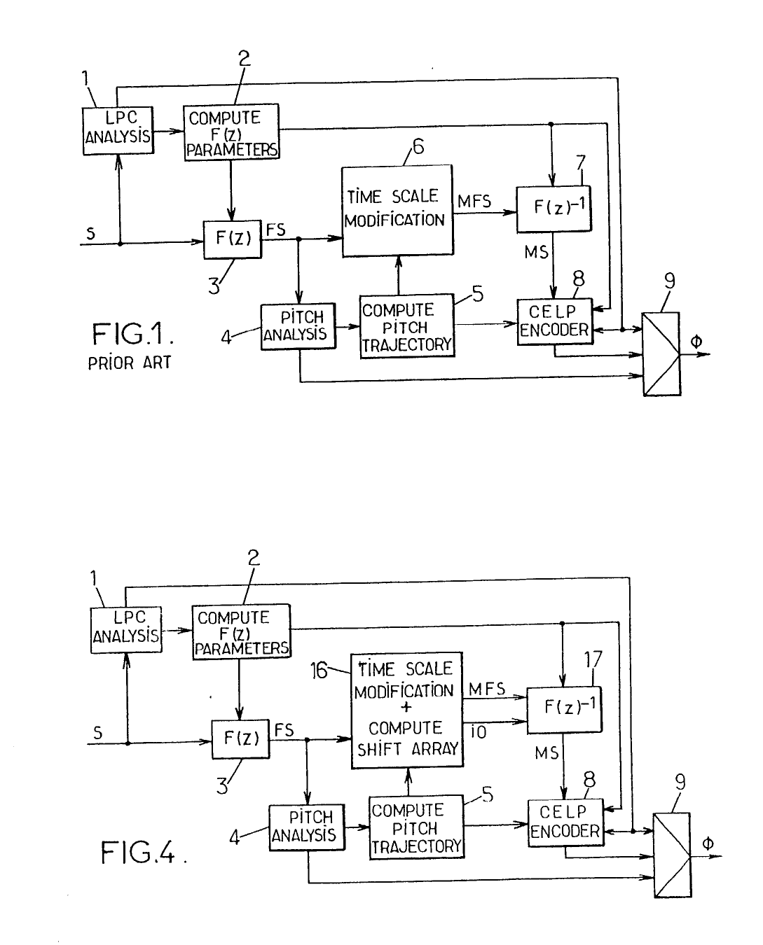

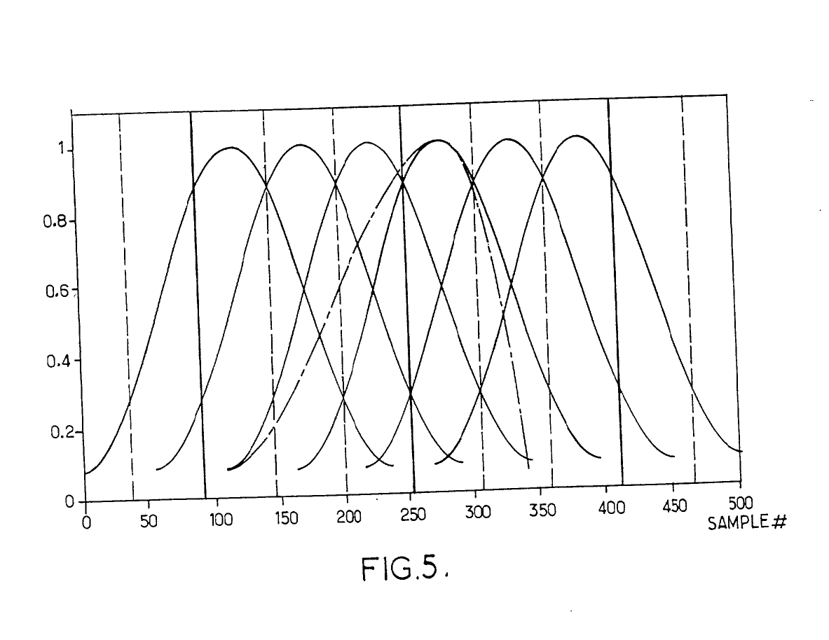

Such improvement of the RCELP scheme is achieved in a coder as exemplified in FIG. 4. With respect to the known structure shown in FIG. 1, the changes are in the time scale modification and inverse filtering modules 16, 17. The other elements 1-5 and 8-9 have been represented with the same references because they can be essentially the same as in the known RCELP coder.

As an illustration, the coder according to the invention, as shown in FIG. 4, can be a low-bit rate narrow-band speech coder having the following features:

the frame length is 20 ms, i.e. 160 samples at a 8 kHz sampling rate;

each frame is divided into p=3 subframes (blocks) of 53, 53 and 54 samples, respectively, with a look-ahead window of 90 samples. FIG. 4 illustrates the various analysis windows used in the LPC analysis module 1. The solid vertical lines are the frame boundaries, while the dashed vertical lines are the subframe boundaries. The symmetric solid curves correspond to the subframe analysis windows, and the asymmetric dash-dot curve represents the analysis window for the look-ahead part. This look-ahead analysis window has the same support as the analysis window pertaining to the third subframe of the frame, but it is centered on the look-ahead region (i.e. its maximum is advanced to be in alignment with the center of the first subframe of the next frame);

a short-term LP model of order 10 is used by the LPC analysis module 1 to represent the spectral envelope of the signal. The corresponding LP filter A(z) is calculated for each subframe;

the pre-processing filter 3 is an adaptive perceptual weighting filter of the form

$$F ( z ) = A ( z / {γ}_{1} ) / A ( z / {γ}_{2} ) , with A ( z ) = 1 + {\sum }_{i = 1}^{10} {a}_{i} \cdot {z}^{- i}$$

where the aᵢ's are the coefficients of the unquantized 10^{th}-order LP filter. The amount of perceptual weighting, controlled by γ₁ and γ₂, is adaptive to depend on the spectral shape of the signal, e.g. as described in U.S. Pat. No. 5,845,244.

It has been pointed out that one of the causes of signal degradation is the difference in the gains of two consecutive perceptual weighting filters. The bigger the difference, the higher the risk for an audible degradation. Although a significant gain change could happen even when using a non-adaptive weighting filter, i.e. constant values of γ₁ and γ₂, the adaptive weighting filter increases the probability that the two consecutive filter gains are significantly different, since the values of γ₁ and γ₂ can change quite rapidly, which may cause significant gain change from one frame to the next one. The proposed invention is thus of particular interest when using an adaptive weighting filter.

The weighted speech is obtained by filtering the input signal S by means of the perceptual filter 3 whose coefficients defined by the aᵢ′s, γ₁ and γ₂, are updated at the original subframe boundaries, i.e. at digital sample positions 0, 53, 106 and 160. The LT analysis made by module 4 on the weighted speech includes a classification of each frame as either stationary voiced or not. For stationary voiced frames, the pitch trajectory is for example computed by module 5 by means of a linear interpolation of the pitch value corresponding to the last sample of the frame and the pitch value of the end of the previous frame. For non-stationary frames, the pitch trajectory can be set to some constant pitch value.

The time scale modification module 16 may perform, if needed, the time scale modification of the weighted speech on a pitch period basis, as is often the case in RCELP coders. The boundary between two periods is chosen in a low energy region between the two pitch pulses. Then a target signal is computed for the given period by fractional LT filtering of the preceding weighted speech according to the given pitch trajectory. The modified weighted speech should match this target signal. The time scale modification of the weighted speech consists of two steps. In the first step, the pulse of the weighted speech is shifted to match the pulse of the target signal. The optimal shift value is determined by maximizing the normalized cross-correlation between the target signal and the weighted speech. In the second step, the samples preceding the given pulse and that are between the last two pulses, are time-scale modified on the weighted speech. The positions of these samples are proportionally compressed or expanded as a function of the shift operation of the first step. The accumulated delay is updated based on the obtained local shift value, and is saved at the end of each subframe.

The outputs of the time scale modification module 16 are (1) the time-scale modified weighted speech signal MFS and (2) the modified subframe boundaries represented in an array i0 of p+1=4 entries i0[0], i0[1], i0[2], i0[3]. These modified subframe boundaries are computed using the saved accumulated delays, with the constraint: 0≦i0[0]<i0[1]<i0[2]<i0[3]≦160. If the accumulated delays are all zero, the original boundary positions are unchanged, i.e. i0[0]=0, i0[1]=53, i0[2]=106, i0[3]=159.

In the illustrated embodiment, the return to the speech domain is made by means of the inverse filter 17 whose transfer function is F(z)⁻¹=A(z/γ₂)/A(z/γ₁), where the coefficients aᵢ, γ₁ and γ₂ are changed at the sample positions given by the array i0 in the following manner:

for sample positions 0 to i0[0]−1, the filter coefficients of the third subframe of the previous frame are used. Therefore, the filters of the third subframes have to be stored for the duration of at least one more subframe;

for sample positions i0[0] to i0[1]−1, the filter coefficients of the first subframe of the current frame are used;

for sample positions i0[1] to i0[2]−1, the filter coefficients of the second subframe of the current frame are used;

for sample positions i0[2] to i0[3]−1, the filter coefficients of the third subframe of the current frame are used; and

for sample positions i0[3] to 159 (if i0[3]<160), the filter coefficients corresponding to the look-ahead analysis window are used. The filter thus modeled is a good approximation of the filter of the first subframe of the next frame, since they are calculated on analysis windows centered on the same subframe. Using this approximation circumvents the need to introduce additional delay. Otherwise, 54 extra samples are necessary to make the LP analysis of the first subframe of the next frame.

Accordingly, each region of the weighted speech is inverse filtered by the right filters 17, i.e. by the inverse of the filters that were used for the analysis. This avoids sudden energy bursts due to filter gain mismatch (as in FIG. 2).

1. A speech coding method, comprising the steps of:
analyzing an input audio signal to determine a respective set of filter parameters for each one of a succession of blocks of the audio signal;
filtering the input signal in a perceptual weighting filter defined for each block by the determined set of filter parameters to produce a perceptually weighted signal;
modifying a time scale of the perceptually weighted signal based on pitch information to produce a modified filtered signal;
locating block boundaries within the modified filtered signal; and
processing the modified filtered signal to obtain coding parameters,
wherein said processing involves an inverse filtering operation corresponding to the perceptual weighting filter, and wherein the inverse filtering operation is defined by the successive sets of filter parameters updated at the located block boundaries.

2. The method as claimed in claim 1, wherein the perceptual weighting filter is an adaptive perceptual weighting filter.

3. The method as claimed in claim 2, wherein the perceptual weighting filter has a transfer function of the form A(z/γ₁)/A(z/γ₂), where A(z) is a transfer function of a linear prediction filter estimated in the step of analyzing the input signal and γ₁ and γ₂ are adaptive coefficients for controlling an amount of perceptual weighting.

4. The method as claimed in claim 1, wherein the step of locating block boundaries comprises accumulating a delay resulting from the time scale modification applied to samples of each block of the perceptually weighted signal, and saving the accumulated delay value at the end of the block to locate a block boundary within the modified filtered signal.

5. The method as claimed in claim 1, wherein the step of analyzing the input signal comprises a linear prediction analysis carried out on successive signal frames, each frame being made of a number p of consecutive subframes where p is a integer at least equal to 1, wherein each of said blocks consists of a respective one of said subframes, and wherein the step of locating block boundaries comprises, for each frame, determining an array of p+1 values for locating the boundaries of the p subframes of said frame within the modified filtered signal.

6. The method as claimed in claim 5, wherein the linear prediction analysis is applied to each subframe by means of a analysis window function centered on said subframe,
wherein the step of analyzing the input signal further comprises, for a current frame, a look-ahead linear prediction analysis by means of an asymmetric look-ahead analysis window function having a support which does not extend in advance with respect to the support of the analysis window function centered on the last subframe of the current frame and a maximum aligned on a time position located in advance with respect to the center of said last subframe,
and wherein in response to the (p+1)^{th} value of the array determined for the current frame falling short of the end of the frame, the inverse filtering operation is updated at the block boundary located by said (p+1)^{th} value to be defined by a set of filter coefficients determined from the look-ahead analysis.

7. The method as claimed in claim 6, wherein the look-ahead analysis window function has its maximum aligned on the center of the first subframe of the frame following the current frame.

8. The method as claimed in claim 1, wherein the coding parameters obtained in the step of processing the modified filtered signal comprise CELP coding parameters.

9. A speech coder, comprising:
means for analyzing an input audio signal to determine a respective set of filter parameters for each one of a succession of blocks of the audio signal;
a perceptual weighting filter defined for each block by the determined set of filter parameters, for filtering the input signal and producing a perceptually weighted signal;
means for modifying a time scale of the perceptually weighted signal based on pitch information to produce a modified filtered signal;
means for locating block boundaries within the modified filtered signal; and
means for processing the modified filtered signal to obtain coding parameters,
wherein said processing involves an inverse filtering operation corresponding to the perceptual weighting filter, and wherein the inverse filtering operation is defined by the successive sets of filter parameters updated at the located block boundaries.

10. The speech coder as claimed in claim 9, wherein the perceptual weighting filter is an adaptive perceptual weighting filter.

11. The speech coder as claimed in claim 10, wherein the perceptual weighting filter has a transfer function of the form A(z/γ₁)/A(z/γ₂), where A(z) is a transfer function of a linear prediction filter estimated by the means for analyzing the input signal and γ₁ and γ₂ are adaptive coefficients for controlling an amount of perceptual weighting.

12. The speech coder as claimed in claim 9, wherein the means for locating block boundaries comprise means for accumulating a delay resulting from the time scale modification applied to samples of each block of the perceptually weighted signal, and for saving the accumulated delay value at the end of the block to locate a block boundary within the modified filtered signal.

13. The speech coder as claimed in claim 9, wherein the means for analyzing the input signal comprises means for carrying out a linear prediction analysis on successive signal frames, each frame being made of a number p of consecutive subframes where p is a integer at least equal to 1, wherein each of said blocks consists of one of said subframes, and wherein the means for locating block boundaries comprises means for determining, for each frame, an array of p+1 values for locating the boundaries of the p subframes of said frame within the modified filtered signal.

14. The speech coder as claimed in claim 13, wherein the linear prediction analysis means are arranged to process to each subframe by means of a analysis window function centered on said subframe,
wherein the means for analyzing the input signal further comprise look-ahead linear prediction analysis means to process a current frame by means of an asymmetric look-ahead analysis window function having a support which does not extend in advance with respect to the support of the analysis window function centered on the last subframe of the current frame and a maximum aligned on a time position located in advance with respect to the center of said last subframe,
and wherein the means for processing the modified filtered signal are arranged to update the inverse filtering operation at the block boundary located by the (p+1)^{th} value of the array determined for the current frame, in response to said (p+1)^{th} value falling short of the end of the current frame, so as to define the updated inverse filtering operation by a set of filter coefficients determined from the look-ahead analysis.

15. The speech coder as claimed in claim 14, wherein the look-ahead analysis window function has its maximum aligned on the center of the first subframe of the frame following the current frame.

16. The speech coder as claimed in claim 9, wherein the coding parameters obtained by the means for processing the modified filtered signal comprise CELP coding parameters.
